(19) United States
(12) Patent Application Publication
(10) Pub. No.: US 2014/0046769 A1
(43) Pub. Date: Feb. 13, 2014

(54) ADVERTISEMENT DELIVERY APPARATUS, ADVERTISEMENT DELIVERY METHOD, TERMINAL ESTIMATING APPARATUS, AND TERMINAL ESTIMATING METHOD

(71) Applicant: YAHOO JAPAN CORPORATION, Tokyo (JP)

(72) Inventors: Akira TAJIMA, Tokyo (JP); Masashi TSUBOSAKA, Tokyo (JP)

(73) Assignee: YAHOO JAPAN CORPORATION, Tokyo (JP)

(21) Appl. No.: 13/964,372

(22) Filed: Aug. 12, 2013

(30) Foreign Application Priority Data
Aug. 13, 2012 (JP) 2012-179506

(51) Int. Cl. G06Q 30/02

(52) U.S. Cl. CPC G06Q 30/0267
USPC 705/14.64

(57) ABSTRACT

An advertisement delivery apparatus includes a related information acquiring unit, a similarity determining unit, terminal estimating unit, and an advertisement delivery unit. The related information acquiring unit receives a plurality of pieces of related information from each of communication terminals. The related information is information about each of the communication terminals and is unable to identify each of the communication terminals. The similarity determining unit determines similarity of the pieces of the related information received from the communication terminals. The terminal estimating unit estimates that the communication terminals are a same communication terminal based on the similarity. The advertisement delivery unit, when the communication terminals are determined as the same terminal, delivers an advertisement corresponding to a behavior of a same user to the communication terminals each serving as a transmission source of the related information.

### CROSS-REFERENCE TO RELATED APPLICATIONS

The present application claims priority to and incorporates by reference the entire contents of Japanese Patent Application No. 2012-179506 filed in Japan on Aug. 13, 2012.

### BACKGROUND OF THE INVENTION

1. Field of the Invention

The present invention relates to an advertisement delivery apparatus, an advertisement delivery method, a terminal estimating apparatus, and a terminal estimating method.

2. Description of the Related Art

As an advertisement delivery method, behavioral targeting advertising has been known that estimates the interest of a user by analyzing behaviors of the user and delivers advertisements that match the interest of the user. Japanese Patent Application Laid-open No. 2010-136332 discloses a method for providing targeted advertisements to a user of an image forming apparatus.

In a smart device, such as a smartphone or a tablet computer, advertisements are displayed while application programs are running. However, it is needed to prevent identification information (a terminal ID) of the smart device from being leaked to the outside. Therefore, even when advertisement delivery requests are received from a plurality of applications installed in a single smart device, it is difficult to determine whether the applications are executed by the same smart device. Consequently, it is difficult to provide behavioral targeting advertising over a plurality of applications.

### SUMMARY OF THE INVENTION

It is an object of the present invention to at least partially solve the problems in the conventional technology.

According to one aspect of an embodiment of the present invention, an advertisement delivery apparatus delivers an advertisement according to a behavior of a user. The advertisement delivery apparatus includes a related information acquiring unit, a similarity determining unit, a terminal estimating unit, and an advertisement delivery unit. The related information acquiring unit receives a plurality of pieces of related information from each of communication terminals. The related information is information about each of the communication terminals and is unable to identify each of the communication terminals. The similarity determining unit determines similarity of the pieces of the related information received from the communication terminals. The terminal estimating unit estimates that the communication terminals are a same communication terminal based on the similarity. The advertisement delivery unit, when the communication terminals are determined as the same terminal, delivers an advertisement corresponding to a behavior of a same user to the communication terminals each serving as a transmission source of the related information.

According to another aspect of an embodiment of the present invention, an advertisement delivery method is executed by a computer that delivers an advertisement according to a behavior of a user. The advertisement delivery method includes receiving a plurality of pieces of related information from each of communication terminals, the related information being information about each of the communication terminals and being unable to identify each of the communication terminals, determining similarity of the pieces of the related information received from the communication terminals, estimating that the communication terminals are a same communication terminal based on the similarity, and delivering, when the communication terminals are determined as the same terminal, an advertisement corresponding to a behavior of a same user to the communication terminals each serving as a transmission source of the related information.

According to still another aspect of an embodiment of the present invention, a terminal estimating apparatus includes a related information acquiring unit, a similarity determining unit, and a terminal estimating unit. The related information acquiring unit receives a plurality of pieces of related information from each of communication terminals. The related information is information about each of the communication terminals and is unable to identify each of the communication terminals. The similarity determining unit determines similarity of the pieces of the related information received from the communication terminals. The terminal estimating unit estimates that the communication terminals are a same communication terminal based on the similarity.

According to still another aspect of an embodiment of the present invention, a terminal estimating method which is executed by a computer, includes receiving a plurality of pieces of related information from each of communication terminals, the related information being information about each of the communication terminals and being unable to identify each of the communication terminals, determining similarity of the pieces of the related information received from the communication terminals, and estimating that the communication terminals are a same communication terminal based on the similarity.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an overall configuration of an advertisement delivery system according to an embodiment of the present invention;

FIG. 2 is a diagram illustrating an example of an advertisement displayed on a user terminal;

FIG. 3 is a diagram illustrating a hardware configuration example of the user terminal;

FIG. 4 is a diagram illustrating a software configuration example of the user terminal;

FIG. 5 is a diagram illustrating a hardware configuration example of an advertisement delivery apparatus;

FIG. 6 is a diagram illustrating a software configuration example of the advertisement delivery apparatus;

FIG. 7 is a diagram illustrating a configuration example of advertisement information stored in an advertisement information storage unit;

FIG. 8 is a diagram illustrating a configuration example of access information stored in an access history storage unit;

FIG. 9 is a diagram illustrating a configuration example of behavior information registered in a behavior history storage unit;

FIG. 10 is a diagram illustrating a configuration example of application information stored in an application storage unit;

FIG. 11 is a diagram illustrating the flow of an advertisement delivery process performed by the advertisement delivery apparatus according to the embodiment;

FIG. 12 is a diagram illustrating the flow of a process for specifying an application program installed in the same user terminal; and

FIG. 13 is a diagram illustrating the flow of a process for generating a match list.

### DETAILED DESCRIPTION OF THE PREFERRED EMBODIMENTS

### 1. System Configuration

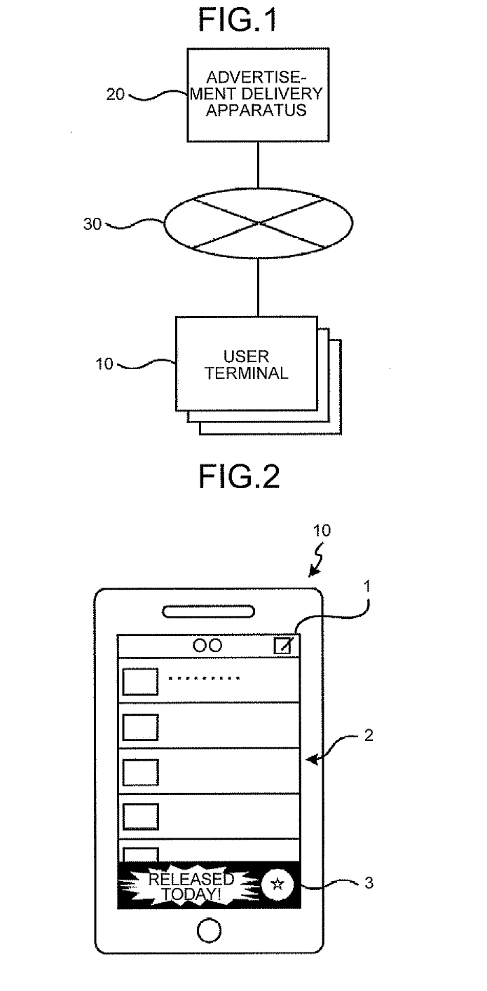

FIG. 1 is a diagram illustrating an overall configuration of an advertisement delivery system according to an embodiment of the present invention. The advertisement delivery system of the embodiment includes an advertisement delivery apparatus 20. A plurality of user terminals 10 are communicably connected to the advertisement delivery apparatus 20 via a communication network 30. The communication network 30 is assumed as the Internet and includes, for example, a mobile phone network, a wireless communication network, a public phone network, a dedicated communication network, or the Ethernet (registered trademark).

The user terminal 10 (corresponding to a communication terminal of the embodiment) is a smart device, such as a smartphone or a tablet computer, operated by a user. The user terminal 10 executes various application programs. It is assumed that the advertisement delivery system of the embodiment delivers an advertisement that is displayed during execution of an application program. FIG. 2 is a diagram illustrating an example of an advertisement displayed on the user terminal 10. On a screen 1, an output 2 from a process of an application program (hereinafter, referred to as an application) being executed and an advertisement 3 are displayed together.

The advertisement delivery apparatus 20 is a computer, such as a workstation or a personal computer, which provides an advertisement to the user terminal 10. In the embodiment, an advertisement to be delivered from the advertisement delivery apparatus 20 to the user terminal 10 is transmitted by Hypertext Transfer Protocol (HTTP), and an advertisement delivery request can be issued as an HTTP request designating a predetermined uniform resource locator (URL) used to deliver the advertisement (hereinafter, referred to as a delivery URL).

The advertisement delivery system of the embodiment is configured such that even when it is difficult to acquire identification information for identifying the user terminal 10 (for example, an ID unique to a subscriber or a terminal ID) from applications, the advertisement delivery system presumes that the advertisement delivery requests from a plurality of applications have been transmitted by the same user terminal 10 based on information which is about the user terminal 10 but which is unable to identify the user terminal 10 (hereinafter, referred to as related information), so as to efficiently provide behavioral targeting advertising.

### 2. Hardware Configuration of the User Terminal 10

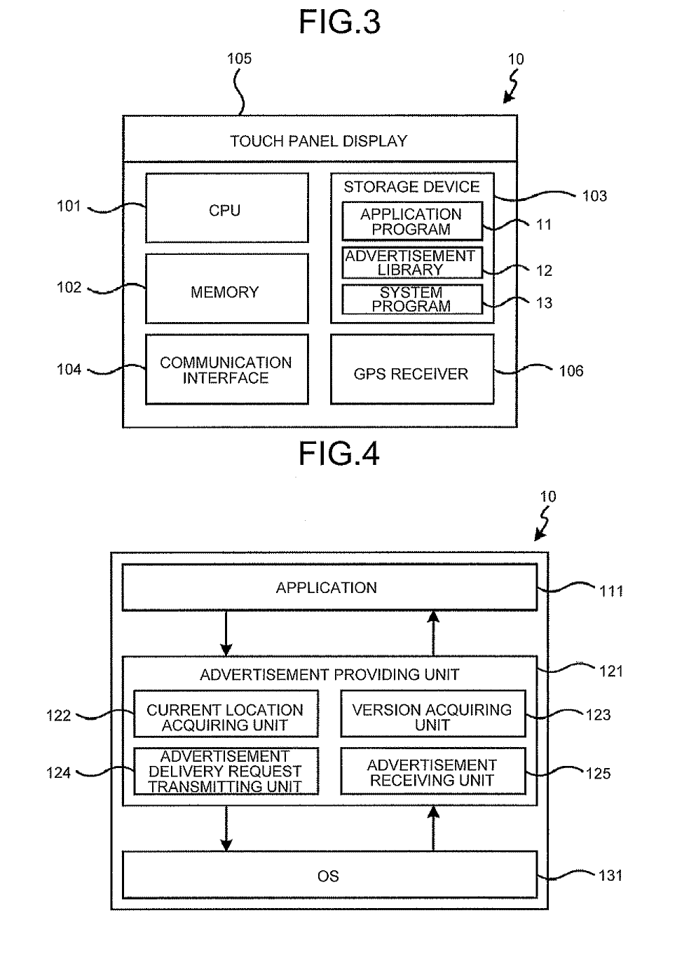

FIG. 3 is a diagram illustrating a hardware configuration example of the user terminal 10. The user terminal 10 includes a central processing unit (CPU) 101, a memory 102, a storage device 103, a communication interface 104, a touch panel display 105, and a GPS receiver 106.

The storage device 103 is a flash memory for storing various types of data and programs. Alternatively, the storage device 103 may be a hard disk drive or a solid state drive for example. The storage device 103 stores therein a plurality of application programs 11, an advertisement library 12, and a system program 13.

The system program 13 is a program for implementing an operating system. The application programs 11 are user programs, such as a game program, a shopping program, an e-mail program, and a utility program. The advertisement library 12 is a program in which a routine is written for acquiring the advertisement 3 to be displayed during execution of any of the application programs 11. By calling an advertisement acquisition routine provided by the advertisement library 12 at the time of execution of the application program 11, it is possible to easily acquire an advertisement from an application. In the embodiment, the advertisement library 12 is stored as a program independent of the application programs 11, and an application dynamically calls the routine from the advertisement library 12 so as to be able to acquire an advertisement. The advertisement library 12 may be provided as a software development kit (SDK) by an operator of the advertisement delivery apparatus 20 and may be incorporated as a part of the application programs 11.

The storage device 103 can store therein various programs in addition to the application programs 11, the advertisement library 12, and the system program 13. The CPU 101 reads the programs into the memory 102 and executes the programs to implement various functions.

The communication interface 104 is an interface for connecting to the communication network 30, and is assumed as a wireless communication device for connecting to a mobile phone network or a wireless communication network. Alternatively, for example, the communication interface 104 may be an adapter for connecting to the Ethernet (registered trademark) or a modem for connecting to a public phone network depending on a communication channel to which the user terminal 10 is connected.

The touch panel display 105 is a multi-touch display capable of detecting a plurality of points of touch to input and output data. A user inputs data by performing operations, such as, touching, tapping, or swiping, on the touch panel display 105. The GPS receiver 106 is a receiver for receiving a positioning signal from a GPS satellite. A current location of the user terminal 10 can be determined by using the positioning signal received by the GPS receiver 106.

### 3. Software Configuration of the User Terminal 10

FIG. 4 is a diagram illustrating a software configuration of the user terminal 10. The user terminal 10 includes an application 111, an advertisement providing unit 121, and an operating system (OS) 131. The application 111, the advertisement providing unit 121, and the operating system 131 are implemented by causing the CPU 101 to read the application programs 11, the advertisement library 12, and the system program 13 stored in the storage device 103 into the memory 102 and execute the programs.

The application 111 is a process implemented by executing the application program 11. The application 111 calls the advertisement providing unit 121 to acquire information for displaying the advertisement 3 (hereinafter, referred to as advertisement information) while being executed, and displays the advertisement 3 as illustrated in FIG. 2. The operating system 131 provides various functions to the application 111 and the advertisement providing unit 121. For example, the application 111 and the advertisement providing unit 121 are enabled to perform communication via the communication network 30 by using a communication function provided by the operating system 131.

The advertisement providing unit 121 provides the advertisement information to the application 111. The advertisement providing unit 121 includes a current location acquiring unit 122, a version acquiring unit 123, an advertisement delivery request transmitting unit 124, and an advertisement receiving unit 125.

The current location acquiring unit 122 acquires the current location of the user terminal 10. In the embodiment, the operating system 131 calculates the current location of the user terminal 10 based on the positioning signal received by the GPS receiver 106, and the current location acquiring unit 122 can acquire the current location of the user terminal 10 by sending a query to the operating system 131.

If the user terminal 10 is connected to the mobile phone network, the current location acquiring unit 122 may calculate the current location of the user terminal 10 based on only location information of the base station, or based on both of the GPS positioning signal and the location information of the base station. Furthermore, if the user terminal 10 is connected to an access point at a known installation location via Wireless Fidelity (WiFi), the current location acquiring unit 122 may calculate the current location of the user terminal 10 based on only the installation location of the access point or based on both of the GPS positioning signal and the installation location of the access point. Moreover, the current location may be calculated based on all of the GPS positioning signal, the location information of the base station, and the installation location of the access point. The current location acquiring unit 122 may measure the location of the user terminal 10 by various general positioning methods.

The current location acquired by the current location acquiring unit 122 is used to estimate the identity of a terminal, and precise current location is not used. Therefore, the positioning accuracy of the current location can be low, and it is sufficient to acquire the current location to the extent that the privacy of the user may not be invaded. For example, it may be possible to acquire the current location with a predetermined margin of error (for example, about 300 meters to 1 kilometer) based on only a signal from the base station of a mobile phone. Alternatively, the current location acquiring unit 122 may specify an area (for example, a municipality or a region indicated by a mesh pattern) on a map in which the user terminal 10 is located.

The version acquiring unit 123 acquires a version of a program stored in the user terminal 10. In the embodiment, the version acquiring unit 123 acquires a version of the system program 13. For example, the version acquiring unit 123 can acquire the version of the system program 13 by sending a query to the operating system 131.

The advertisement delivery request transmitting unit 124 transmits an advertisement delivery request to the advertisement delivery apparatus 20. The advertisement delivery request transmitting unit 124 transmits an advertisement delivery request to the advertisement delivery apparatus 20 by setting, in the advertisement delivery request, an ID to identify the application program 11 for implementing the application 111 that has called the advertisement providing unit 121 (hereinafter, the ID is referred to as an application ID), the current location of the user terminal 10 acquired by the current location acquiring unit 122, the version of the system program 13 acquired by the version acquiring unit 123, and a behavior history of a user using the application 111, such as an operation history or a game score of the user using the application 111 or a product/service purchase history using the application 111.

In the embodiment, the advertisement delivery request transmitting unit 124 transmits the advertisement delivery request by HTTP, and the application ID is issued as an HTTP cookie (a cookie) by the advertisement delivery apparatus 20. Therefore, when the advertisement delivery request transmitting unit 124 transmits the advertisement delivery request to the advertisement delivery apparatus 20 for the first time, the application ID is omitted because the cookie does not exist. When the advertisement delivery apparatus 20 delivers an advertisement in response to the first advertisement delivery request, the advertisement delivery apparatus 20 issues an application ID and transmits the application ID as a cookie. The behavior history is information on behaviors of the user. For example, the behavior history may be a game score history when the application 111 is a game, or a purchase history when the application 111 is used for shopping. The behavior history may be any information as long as the behavior information can become an object of analysis in general behavioral targeting advertising.

The advertisement receiving unit 125 receives the advertisement information transmitted by the advertisement delivery apparatus 20 in response to the advertisement delivery request. The advertisement receiving unit 125 receives the advertisement information by HTTP. When a cookie is set in an HTTP response, the advertisement receiving unit 125 stores data set in the cookie (hereinafter, referred to as cookie data) in the storage device 103. As described above, in the embodiment, it is assumed that the application ID is set as the cookie data. When the cookie data is stored in the storage device 103, the advertisement delivery request transmitting unit 124 sets the cookie data in an advertisement delivery request and then transmits the advertisement delivery request. The advertisement receiving unit 125 provides the received advertisement information to the application 111. The application 111 that has received the advertisement information displays the advertisement 3 on the screen 1 based on the advertisement information.

### 4. Hardware Configuration of the Advertisement Delivery Apparatus 20

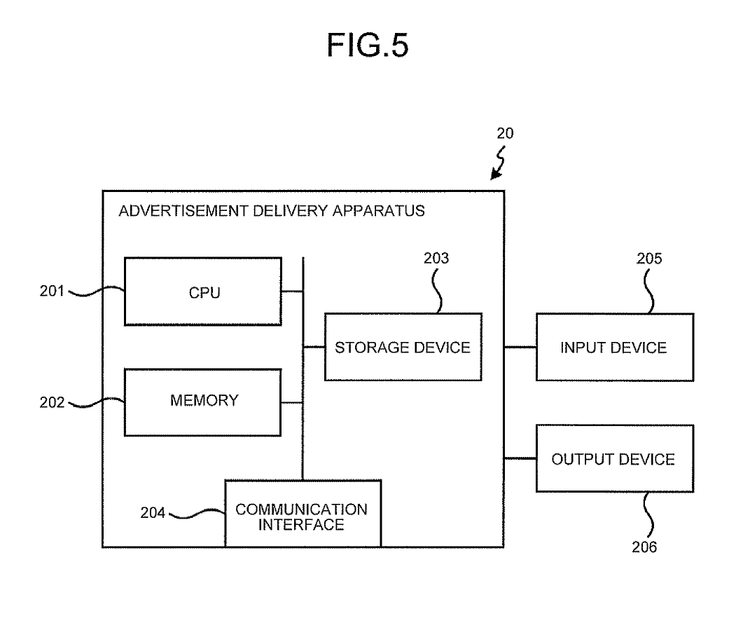

FIG. 5 is a diagram illustrating a hardware configuration example of the advertisement delivery apparatus 20. The advertisement delivery apparatus 20 includes a CPU 201, a memory 202, a storage device 203, a communication interface 204, an input device 205, and an output device 206. The storage device 203 is, for example, a hard disk drive, a solid state drive, or a flash memory, for storing various types of data and programs. The CPU 201 reads programs stored in the storage device 203 into the memory 202 and executes the programs to implement various functions. The communication interface 204 is an interface for connecting to the communication network 30. For example, the communication interface 204 is an adapter for connecting to the Ethernet (registered trademark), a modem for connecting to a public phone network, or a wireless communication device for connecting to a wireless communication network. The input device 205 is, for example, a keyboard, a mouse, a trackball, a touch panel, or a microphone for receiving input of data. The output device 206 is, for example, a display, a printer, or a speaker for outputting data. The advertisement delivery apparatus 20 may include a plurality of the input devices 205 and the output devices 206.

### 5. Software Configuration of the Advertisement Delivery Apparatus 20

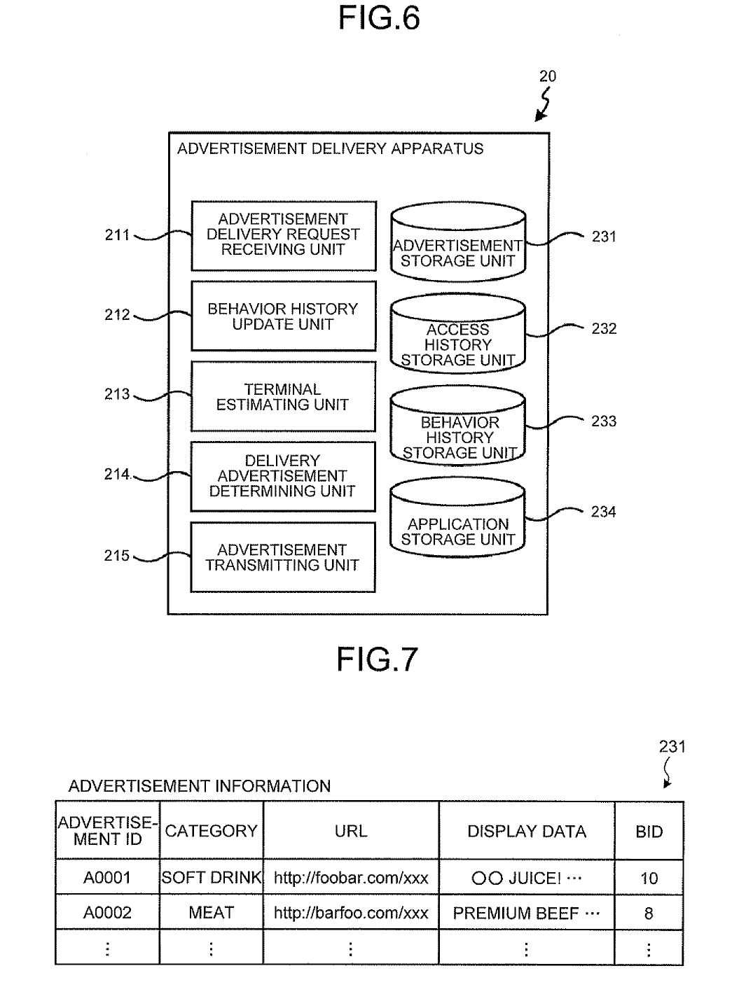

FIG. 6 is a diagram illustrating a software configuration of the advertisement delivery apparatus 20. The advertisement delivery apparatus 20 includes an advertisement delivery request receiving unit 211, a behavior history updating unit 212, a terminal estimating unit 213, a delivery advertisement determining unit 214, an advertisement transmitting unit 215, an advertisement storage unit 231, an access history storage unit 232, a behavior history storage unit 233, and an application storage unit 234. The advertisement delivery request receiving unit 211, the behavior history updating unit 212, the terminal estimating unit 213, the delivery advertisement determining unit 214, and the advertisement transmitting unit 215 are implemented by causing the CPU 201 to read the programs stored in the storage device 203 into the memory 102 and execute the programs. The advertisement storage unit 231, the access history storage unit 232, the behavior history storage unit 233, and the application storage unit 234 are realized as a part of a storage region in the memory 102 or the storage device 103.

The advertisement storage unit 231 stores therein the advertisement information. FIG. 7 is a diagram illustrating a configuration example of the advertisement information stored in the advertisement storage unit 231. The advertisement information contains a category, a URL of a landing page, display data, and a bid, in association with an advertisement ID for identifying an advertisement. The category is a category of an object to be advertised. The display data is data displayed as the advertisement 3 on the user terminal 10. The display data may be text data, may be binary data such as image data or audio data or may be data in which the text data and the binary data are mixed. The bid is the maximum amount of money that is set by an advertiser so as to be paid to the advertiser when the advertisement is clicked.

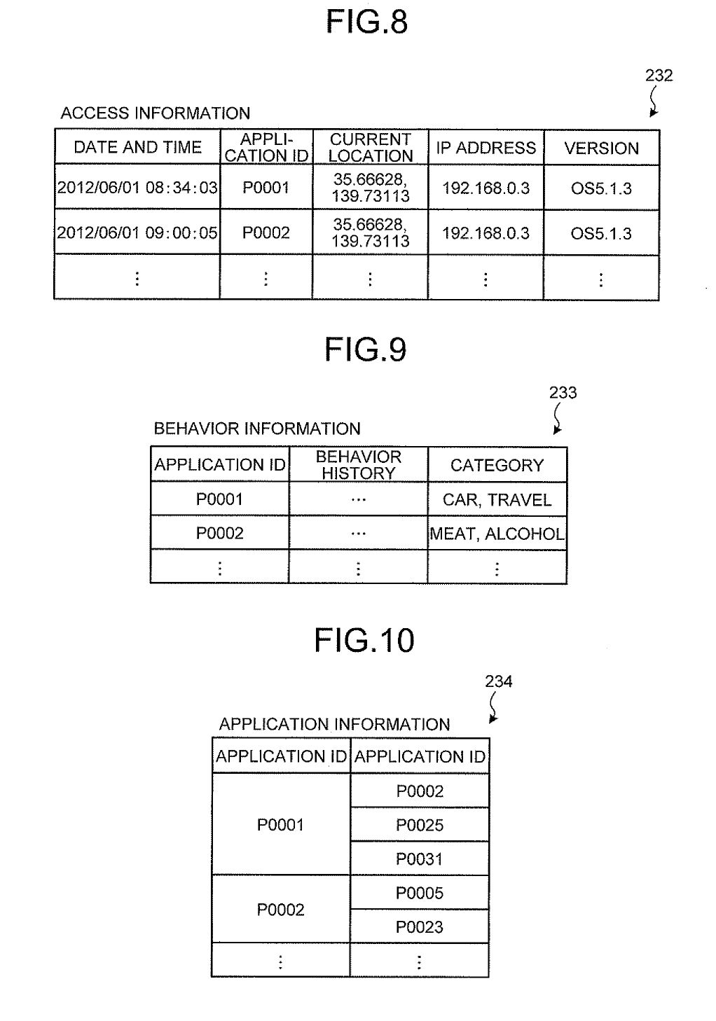

The access history storage unit 232 stores therein information on an access to the advertisement delivery apparatus 20 by the user terminal 10 (hereinafter, referred to as access information). FIG. 8 is a diagram illustrating a configuration example of the access information stored in the access history storage unit 232. The access information contains a date and time, an application ID, a current location, an IP address, and a version. The date and time is a date and time at which the advertisement delivery request receiving unit 211 receives the advertisement delivery request. The application ID and the current location are the same as those set in the advertisement delivery request. The IP address is an IP address of a transmission source of the advertisement delivery request. The IP address indicates the transmission source in communication by HTTP. If the user terminal 10 is a smart device or a mobile phone terminal for example, a gateway of a communication carrier performs network address translation (NAT) or port address translation (PAT), so that transmission sources of packets transmitted by a plurality of the user terminals 10 are set to an IP address of the same gateway. Furthermore, if the user terminal 10 is a smart device or the like, the IP address may change with movement of the user terminal 10. The version is the version of the system program 13 installed in the user terminal 10.

The behavior history storage unit 233 stores therein information on the behavior history of a user of the user terminal 10 (hereinafter, referred to as behavior information). FIG. 9 is a diagram illustrating a configuration example of the behavior information registered in the behavior history storage unit 233. The behavior information contains a behavior history and a category, in association with the application ID. The category is a category of an advertisement that indicates a user's interest estimated based on the behavior history. In the following description, the “category” means any information indicating the user's interest. The category may be any information as long as the information indicates the user's interest. For example, a keyword indicating the user's interest may be used.

The application storage unit 234 stores therein pieces of information on the application programs 11 that are estimated to have been installed in the same user terminal 10 (hereinafter, the information is referred to as application information). FIG. 10 is a diagram illustrating a configuration example of the application information stored in the application storage unit 234. The application information contains application IDs (same-terminal application IDs) of the application programs 11 that are estimated to have been installed in the same user terminal 10 in which a certain application program 11 indicated by a certain application ID has been installed, in association with the certain application ID.

The advertisement delivery request receiving unit 211 receives the advertisement delivery request transmitted by the user terminal 10. The advertisement delivery request receiving unit 211 generates access information according to the advertisement delivery request, and registers the generated access information in the access history storage unit 232.

The behavior history updating unit 212 acquires a behavior history of a user and updates the behavior history storage unit 233. In the embodiment, the behavior history is contained in the advertisement delivery request, and the behavior history updating unit 212 acquires this behavior history. If the application ID is not set in the advertisement delivery request, the behavior history updating unit 212 issues a new application ID, generates behavior information containing the issued application ID and the behavior history, and registers the generated behavior information in the behavior history storage unit 233. If the application ID is set in the advertisement delivery request, the behavior history in the behavior information corresponding to the application ID is updated with the behavior history contained in the advertisement delivery request. The behavior history updating unit 212 analyzes the behavior history to determine a category in which user is interested in, and sets the determined category in the behavior information to be registered in the behavior history storage unit 233. A process for determining the category based on the behavior history can be performed by using a general method employed in general behavioral targeting advertising.

The terminal estimating unit 213 estimates the application program 11 installed in the same user terminal 10.

In the embodiment, it is assumed that the advertisement delivery request does not contain identification information for identifying the user terminal 10 (or for identifying a user operating the user terminal 10), and it is also assumed that the user terminal 10 is not identified based on the IP address. For example, even if the user terminal 10 is to be identified by using only the IP address of a transmission source of the advertisement delivery request, the IP address changes with movement of the user terminal 10 when the user terminal 10 is a portable device such as a smart device, or the same IP address is used by a plurality of the user terminals 10 to communicate with the advertisement delivery apparatus 20 when the user terminals 10 use a gateway of a communication carrier such as a mobile phone company. Therefore, when receiving the advertisement delivery requests from different applications, it is difficult to determine whether the same user terminal 10 has transmitted the advertisement delivery requests. Consequently, it is difficult to reliably determine which application programs 11 are installed in the same user terminal 10. To deal with this, in the embodiment, the terminal estimating unit 213 acquires a plurality of pieces of information which are about the user terminal 10 but which is unable to identify the user terminal 10 (hereinafter, referred to as the related information) from each of the user terminals 10, and determines whether the user terminals 10 are the same depending on the similarity of the pieces of the related information.

In the embodiment, the pieces of the related information are a date and time of reception of the advertisement delivery request, an IP address, a current location of the user terminal 10, and a version of the system program 13 installed in the user terminal 10. The similarity indicates the number of pieces of the related information which are the same or differences of which are within a predetermined value.

The delivery advertisement determining unit 214 determines an advertisement to be delivered. In the embodiment, the delivery advertisement determining unit 214 acquires a category associated with the application ID set in the advertisement delivery request from the behavior history storage unit 233, and determines, as advertisements to be delivered (hereinafter, referred to as delivery advertisements), a predetermined number of pieces of advertisement information that are registered in the advertisement storage unit 231 in association with the category, in order from the highest bid. A process for determining advertisements to be delivered will be explained in detail below.

The advertisement transmitting unit 215 transmits the delivery advertisements determined by the delivery advertisement determining unit 214 to the user terminal 10 serving as the transmission source of the advertisement delivery request. The advertisement transmitting unit 215 transmits the delivery advertisements by HTTP. If the application ID is set in the advertisement delivery request, the advertisement transmitting unit 215 sets the application ID as the cookie, and if not, sets the application ID issued by the behavior history updating unit 212 as the cookie.

### 6. Advertisement Delivery Process

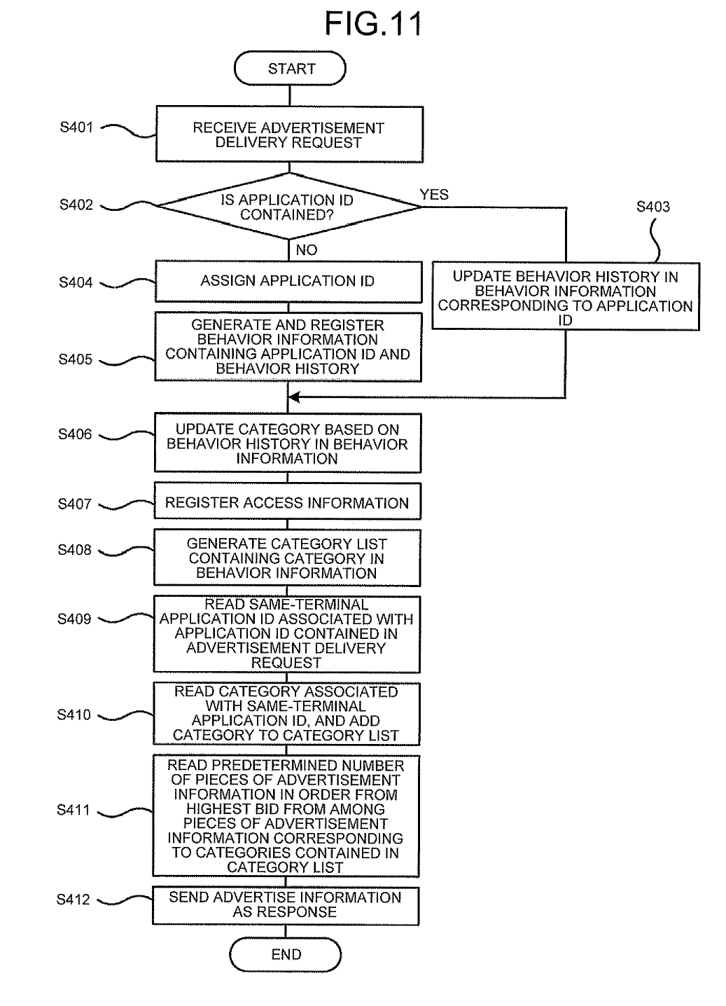

FIG. 11 is a diagram illustrating the flow of an advertisement delivery process performed by the advertisement delivery apparatus 20 of the embodiment.

When the advertisement delivery request receiving unit 211 receives the advertisement delivery request from the user terminal 10 (S401), and if the advertisement delivery request contains the application ID (YES at S402), the behavior history updating unit 212 updates the behavior history in the behavior information corresponding to the application ID with the behavior history contained in the advertisement delivery request (S403). The advertisement delivery request may contain only a difference in the behavior history such that the difference is added to the behavior history in the behavior information. Alternatively, the advertisement delivery request may contain only the behavior history for each date and time such that only the behavior history at a date and time that is not contained in the behavior information is added to the behavior information.

When the advertisement delivery request does not contain the application ID (NO at S402), the behavior history updating unit 212 assigns a new application ID to a transmission source of the advertisement delivery request (S404), generates behavior information containing the assigned application ID and the behavior history that has been contained in the advertisement delivery request, and registers the generated behavior information in the behavior history storage unit 233 (S405).

The behavior history updating unit 212 analyzes the behavior history in the behavior information updated or generated as described above to thereby determine a category that a user is interested in, and updates the category in the behavior information with the determined category (S406). Meanwhile, it may be possible to determine a plurality of categories. The category is determined by a general process employed in behavioral targeting advertising.

The advertisement delivery request receiving unit 211 generates access information containing a current date and time, either the application ID contained in the advertisement delivery request or the application ID assigned by the behavior history updating unit 212, the current location and the version contained in the advertisement delivery request, and the IP address of the transmission source of the advertisement delivery request, and registers the generated access information in the access history storage unit 232 (S407).

The delivery advertisement determining unit 214 generates a category list containing the category determined as described above (S408). The delivery advertisement determining unit 214 reads the same-terminal application ID associated with the application ID in the behavior information from the application storage unit 234 (S409), reads a category associated with the read same-terminal application ID from the behavior history storage unit 233, and adds the read category in the category list (S410). The delivery advertisement determining unit 214 reads, from the advertisement storage unit 231, a predetermined number of pieces of the advertisement information as advertisements to be delivered, in order from the highest bid among the pieces of the advertisement information corresponding to the categories contained in the category list (S411).

The advertisement transmitting unit 215 transmits the pieces of the advertisement information read by the delivery advertisement determining unit 214 to the user terminal 10 serving as the transmission source of the advertisement delivery request (S412).

As described above, the pieces of the advertisement information corresponding to the categories associated with all of the application IDs estimated to have been installed in the same terminal are transmitted to the user terminal 10.

### 7. Process for Estimating the Same Terminal

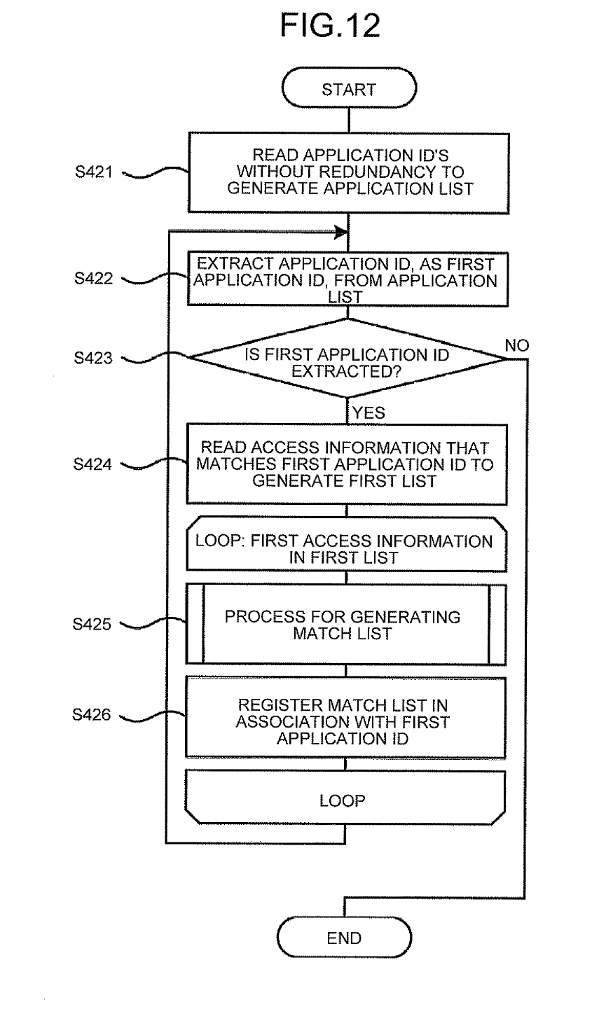

FIG. 12 is a diagram illustrating the flow of a process for specifying the application program 11 installed in the same user terminal 10.

The terminal estimating unit 213 reads application IDs contained in the access information from the access history storage unit 232 without redundancy to thereby generate an application list (S421), and extracts, as a first application ID, an application ID from the application list (S422). When the first application ID is not extracted (NO at S423), the process ends. When the first application ID is extracted (YES at S423), the terminal estimating unit 213 reads pieces of access information that matches the first application ID from the access history storage unit 232 to thereby generate a first list (S424), and performs the following process on each piece of the access information, as first access information, contained in the first list.

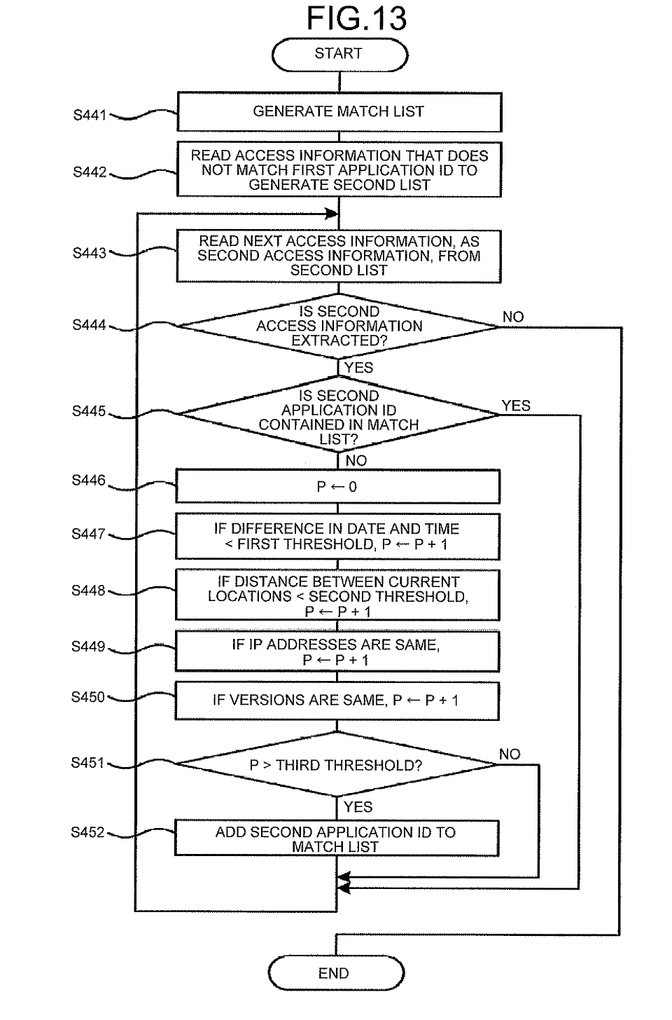

The terminal estimating unit 213 performs a process for generating a match list as illustrated in FIG. 13 (S425). Specifically, the terminal estimating unit 213 generates an empty match list (S441), reads pieces of access information corresponding to application IDs that do not match the first application ID from the access history storage unit 232 to thereby generate a second list (S442), and extracts, as second access information, a next piece of access information from the second list (S443). When the terminal estimating unit 213 does not extract the second access information (NO at S444), the process ends.

When the second access information is extracted (YES at S444), and if the application ID contained in the second access information (hereinafter, referred to as a second application ID) is not contained in the match list (NO at S445), the terminal estimating unit 213 sets a parameter P to zero (S446). If a difference between the date and time in the first access information and the date and time in the second access information is smaller than a predetermined first threshold (for example, an arbitrary time, such as 5 minutes, 10 minutes, or 1 hour, can be set) the parameter P is incremented (S447). If a distance between the current location in the first access information and the current location in the second access information is shorter than a predetermined second threshold (for example, an arbitrary value, such as 500 meters or 1 kilometer, can be set) the parameter P is incremented (S448). If the IP address in the first access information and the IP address in the second access information are the same, the parameter P is incremented (S449). If the version in the first access information and the version in the second access information are the same, the parameter P is incremented (S450).

If the parameter P exceeds a predetermined third threshold (an arbitrary value in the range from 0 to 3 can be set) (YES at S451), the terminal estimating unit 213 determines that the application program 11 indicated by the first application ID and the application program 11 indicated by the second application ID are installed in the same user terminal 10, adds the second application ID to the match list (S452), and repeats the process from Step S443.

As described above, the application ID indicating the application program 11 installed in the same user terminal 10 in which the application program 11 with the first application ID has been installed is added to the match list.

Referring back to FIG. 12, the terminal estimating unit 213 registers the application ID contained in the match list in the application storage unit 234 in association with the first application ID (S426).

By performing the above process on each piece of the first access information contained in the first list, it becomes possible to estimate the application program 11 installed in the same user terminal 10 in which the application program 11 with the first application ID contained in the first access information has been installed, and register the second application ID of the estimated application program 11 in the application storage unit 234 in association with the first application ID.

### 8. Advantages

As described above, according to the advertisement delivery system of the embodiment, it is possible to determine whether advertisement delivery requests are transmitted by the same user terminal 10 based on the similarity of the related information contained in the advertisement delivery requests transmitted by different applications 111. Therefore, even when the user terminal 10 does not transmit information, such as a terminal ID, for identifying the user terminal 10, it is possible to estimate whether a plurality of advertisement delivery requests have been transmitted by the same transmission source based on the related information on the user terminal 10, such as a data transmission date and time at the user terminal 10, the current location of the user terminal 10, the IP address, or the version of the system program 13 installed in the user terminal 10. Consequently, it becomes possible to estimate the user terminal 10 in which the application program 11 is installed, without transmitting information, such as a terminal ID, related to the privacy of a user of the user terminal 10.

Furthermore, it is possible to estimate whether the advertisement delivery requests have been transmitted by the same transmission source based on the related information, such as the IP address, the current location, the version of the system program 13, or the transmission date and time of the advertisement delivery request, which can easily be acquired.

Moreover, in the advertisement delivery system of the embodiment, a behavior history of each of the different application programs 11 is analyzed, and a category that a user may be interested in is estimated for each of the application programs 11. Therefore, when advertisements are to be delivered, it is possible to deliver advertisements corresponding to all of the categories associated with the application IDs of all of the application programs 11 estimated to have been installed in the same user terminal 10. Consequently, it becomes possible to deliver advertisements corresponding to the categories analyzed based on the behavior histories of all of the application programs 11 installed in the same user terminal 10. As a result, it becomes possible to encompass the user's interest when delivering advertisements.

Furthermore, while the user's behavior history that can be collected for each of the applications 111 may be biased, the advertisement delivery system of the embodiment can combine the user's interests (categories) based on the analysis of the behavior history for each of the applications 111. Therefore, it is possible to more accurately deliver advertisements according to categories that the user is interested in.

Moreover, according to the advertisement delivery system of the embodiment, not only the IP address, but also the current location, the version of the system program 13, and the transmission date and time of the advertisement delivery request are used. Therefore, it is possible to estimate whether the same user terminal 10 serves as the transmission source of packets (the advertisement delivery requests) even when the IP address of the transmission source of the packets transmitted by the user terminal 10 changes with a change in the gateway with movement of the user terminal 10. Therefore, it is possible to easily provide the behavioral targeting advertising to a portable device, such as a mobile phone terminal or a smart device.

### 9. Modifications

In the embodiment, the advertisement delivery apparatus 20 is explained as a single computer. However, the advertisement delivery apparatus 20 may include a plurality of computers. In this case, for example, it may be possible to implement at least one of the advertisement storage unit 231, the access history storage unit 232, the behavior history storage unit 233, the application storage unit 234 in a database server such that the advertisement delivery apparatus 20 can access the server, or it may be possible to implement one virtual computer by a plurality of computers and cause the virtual computer to implement the advertisement delivery apparatus 20.

Furthermore, while the advertisement delivery apparatus 20 issues the application ID by using a cookie in the embodiment, it is not limited thereto. For example, it may be possible to embed the application ID for each of the application programs 11 and cause the application 111 to autonomously transmit the application ID.

Moreover, while the application ID is set in the cookie in the embodiment, it is not limited thereto. It may be possible to identify the user terminal 10 without setting the application ID. In this case, an ID for associating the behavior information and the access information is set as the application ID of each of the behavior information and the access information; access information with high similarity to the latest access information is specified (that is, information for which a difference in the date and time is within a predetermined time period, a difference in the current location is within a predetermined value, and the number of trues for the determination on whether the IP addresses and the versions are the same is equal to or greater than a predetermined threshold is specified); and a category is determined based on the behavior histories of the pieces of the behavior information corresponding to the latest access information and the specified access information.

Furthermore, while the user's interest (category) is determined based on the behavior history contained in the behavior information in the embodiment, it is not limited thereto. It may be possible to analyze the user's interest based on all of the behavior histories. In this case, for example, the same-terminal application ID associated with the application ID of the first behavior information is acquired from the application storage unit 234, the behavior history in the second behavior information associated with the acquired same-terminal application ID is read, and all of the read behavior histories in the second behavior information and the first behavior information are analyzed to determine the category that the user is interested in. Therefore, it becomes possible to analyze the user's interest based on the increased number of the behavior histories, so that it becomes possible to more accurately specify the user's interest. As a result, it becomes possible to deliver advertisements with the increased advertising effectiveness according to the user's interest.

Moreover, while the behavior history is contained in the advertisement delivery request and transmitted from the user terminal 10 in the embodiment, it may be possible to transmit the behavior history from the user terminal 10 to the advertisement delivery apparatus 20 separately from the advertisement delivery request. Besides, the behavior history updating unit 212 may acquire the user's behavior history by, for example, acquiring a purchase history by accessing an electronic commerce (EC) site.

Furthermore, while the date and time, the IP address, the current location, and the version contained in the access information are used as the related information in the embodiment, it is not limited thereto. Any information that is about the user terminal 10 and that can be contained in the advertisement delivery request may be used.

Moreover, while the similarity of the related information is calculated by equally evaluating a difference in the date and time, a distance between the current locations, the sameness of the ID addresses, and the sameness of the versions in the embodiment, the similarity may be calculated by weighting the items. Moreover, at Step S442, it may be possible to read only access information which corresponds to an application ID different from the first application ID and for which a difference in the date and time with respect to the date and time in the first access information is smaller than a first threshold.

Furthermore, while the second threshold for the distance between the current locations is assumed as a predetermined constant at Step S448 in FIG. 13, it is not limited thereto. For example, the value may be determined depending on a difference in the date and time obtained at Step S447. In this case, for example, it may be possible to represent a difference in the date and time by seconds or minutes, and multiply the seconds or minutes by a predetermined distance (for example, an arbitrary distance, such as 10 meters or 100 meters, can be set) to calculate the second threshold. Specifically, it may be possible to calculate an average of movement distances per unit time (for example, 1 second or 1 minute) in a past predetermined time period based on the current location in the access information corresponding to the first application ID, and multiply the difference in the date and time by the average. Alternatively, it may be possible to add an error in the measurement of the current location to the second threshold.

Moreover, in the embodiment, it is estimated that the application program 11 indicated by the second application ID and the application program 11 indicated by the first application ID are installed in the same user terminal 10 if any piece of the access information corresponding to the second application ID has certain similarity (that is, if the parameter P is greater than the third threshold). However, for example, it may be possible to estimate that the application programs are installed in the same user terminal 10 depending on the number of pieces of similar access information. In this case, it is possible to omit Step S445 in FIG. 13, and, after all pieces of the second access information are extracted (NO at S444), the terminal estimating unit 213 can estimate that the application programs 11 indicated by the second application ID and the first application ID are installed in the same user terminal 10 depending on the number of the second application IDs contained in the match list. With this configuration, it becomes possible to improve the estimation accuracy. Besides, at Step S441 in FIG. 13, it may be possible to generate a mismatch list in addition to the match list. In this case, when the parameter P is equal to or smaller than the third threshold (NO at S451), the second application ID is added to the mismatch list such that the application programs 11 indicated by the first application ID and the second application ID are estimated to have been installed in the same user terminal 10 depending on the number of the second application IDs contained in the match list and the number of the second application IDs contained in the mismatch list. With this configuration, it becomes possible to further improve the estimation accuracy.

Furthermore, in the embodiment, the estimation process of the same user terminal 10 is performed by using all pieces of the access information as objects; however, it is not limited thereto. It may be possible to perform the estimation process with a predetermined period. In this case, for example, in the process illustrated in FIG. 13, it may be possible to classify the pieces of the access information contained in the second list read at Step S442 into groups by a predetermined time (for example, 5 minutes, 10 minutes, or 1 hour), and perform the process at Steps S443 to S452 for each of the groups. In this case, it becomes possible to determine whether the same user terminal 10 is used based on the access information for each predetermined time. If the user terminal 10 is a portable device, such as a smart device or a mobile phone terminal, it is presumed that the current location and the IP address greatly changes with time. Therefore, by performing the estimation process for each period, it becomes possible to prevent erroneous determination caused by movement of the user terminal 10, enabling to more accurately perform the estimation process.

According to an aspect of an embodiment, even when identification information of a communication terminal is not acquired, it is possible to estimate whether a plurality of communication terminals are the same terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery apparatus that delivers an advertisement according to a behavior of a user, the advertisement delivery apparatus comprising:
a related information acquiring unit that receives a plurality of pieces of related information from each of communication terminals, the related information being information about each of the communication terminals and being unable to identify each of the communication terminals;
a similarity determining unit that determines similarity of the pieces of the related information received from the communication terminals;
a terminal estimating unit that estimates that the communication terminals are a same communication terminal based on the similarity; and
an advertisement delivery unit that, when the communication terminals are determined as the same terminal, delivers an advertisement corresponding to a behavior of a same user to the communication terminals each serving as a transmission source of the related information.

2. The advertisement delivery apparatus according to claim 1,
wherein the related information is at least one of an address of a gateway that transfers a packet from each of the communication terminals, a version of a program executed by each of the communication terminals, a current location of each of the communication terminals, and a date and time at which at least one of the address, the version, and the current location is acquired.

3. An advertisement delivery method which is executed by a computer that delivers an advertisement according to a behavior of a user, the advertisement delivery method comprising:
receiving a plurality of pieces of related information from each of communication terminals, the related information being information about each of the communication terminals and being unable to identify each of the communication terminals;
determining similarity of the pieces of the related information received from the communication terminals;
estimating that the communication terminals are a same communication terminal based on the similarity; and
delivering, when the communication terminals are determined as the same terminal, an advertisement corresponding to a behavior of a same user to the communication terminals each serving as a transmission source of the related information.

4. A terminal estimating apparatus comprising:
a related information acquiring unit that receives a plurality of pieces of related information from each of communication terminals, the related information being information about each of the communication terminals and being unable to identify each of the communication terminals;
a similarity determining unit that determines similarity of the pieces of the related information received from the communication terminals; and
a terminal estimating unit that estimates that the communication terminals are a same communication terminal based on the similarity.

5. The terminal estimating apparatus according to claim 4,
wherein the similarity determining unit counts the number of pieces of the related information each being received from a second communication terminal among the communication terminals and each being matched with a corresponding piece of the related information received from a first communication terminal among the communication terminals, and when the counted number of the pieces of the related information is equal to or greater than a predetermined threshold, estimates that the first communication terminal and the second communication terminal are a same terminal.

6. The terminal estimating apparatus according to claim 4,
wherein the related information acquiring unit receives a plurality of pieces of the related information from each of the communication terminals in each of periods,
wherein the similarity determining unit determines the similarity of the pieces of the related information for each of the periods, and estimates that the communication terminals are a same communication terminal depending on the number of periods in which the similarity exceeds a predetermined value.

7. The terminal estimating apparatus according to claim 4,
wherein the related information is at least one of an address of a gateway that transfers a packet from each of the communication terminals, a version of a program executed by each of the communication terminals, a current location of each of the communication terminals, and a date and time at which at least one of the address, the version, and the current location is acquired.

8. A terminal estimating method which is executed by a computer, comprising:
receiving a plurality of pieces of related information from each of communication terminals, the related information being information about each of the communication terminals and being unable to identify each of the communication terminals;
determining similarity of the pieces of the related information received from the communication terminals; and
estimating that the communication terminals are a same communication terminal based on the similarity.
